(19) United States
(12) Patent Application Publication
(10) Pub. No.: US 2024/0370719 A1
(43) Pub. Date: Nov. 7, 2024

(54) Data Generation Method, Model Training Method, Apparatus, Electronic Device, and Medium

(71) Applicant: Beijing Baidu Netcom Science Technology Co., Ltd., Beijing (CN)

(72) Inventors: Congxi XIAO, Beijing (CN); Jizhou HUANG, Beijing (CN); Jingbo ZHOU, Beijing (CN)

(21) Appl. No.: 18/512,766

(22) Filed: Nov. 17, 2023

(30) Foreign Application Priority Data
May 6, 2023 (CN) 202310505558.4

(51) Int. Cl. G06N 3/08; G06N 3/042

(52) U.S. Cl. CPC G06N 3/08; G06N 3/042

(57) ABSTRACT

This disclosure provides a data generation method, model training method, electronic device, and medium. The data generation method includes: obtaining urban graph data, the urban graph data including a node set, an edge set and a feature set, wherein the node set includes a central node corresponding to a predetermined urban entity, the edge set includes a neighborhood corresponding to the central node, the neighborhood includes other nodes in the node set connected to the central node via an edge, and the feature set includes features of nodes in the node set; partitioning a target region into at least two sub-regions to obtain a region partition set; obtaining a regional feature of each sub-region by aggregating features corresponding to all nodes in the sub-region; and updating a feature of the central node based on the regional features of the sub-regions in the region partition set to obtain target feature data.

### CROSS-REFERENCE TO RELATED APPLICATION

The present application claims priority to Chinese patent application No. 202310505558.4 filed in China on May 6, 2023, the disclosure of which is incorporated in its entirety by reference herein.

### TECHNICAL FIELD

The present disclosure relates to the technical field of data processing, and more particularly, to the technical fields of deep learning, smart city, and urban governance, and the like. In particular, the present disclosure relates to a data generation method, a model training method, an apparatus, an electronic device, and a medium.

### BACKGROUND

With the continuous acceleration of the global urbanization process, the sizes of cities are increasing continuously. In order to realize the long-term development of cities, the concept of smart city gradually gains popularity, and urban intelligent computing has important significance for improving urban governance level, improving public service quality, and developing digital economy. The related art in the field of urban intelligent computing proposes that a city can be modeled, various urban entities (such as a region, an interest point, a road) are represented, and the representations are transformed into computable vector representations. In this way, the process of urban intelligent computing can be simplified.

### SUMMARY

According to a first aspect of the present disclosure, a data generation method is provided. The data generation method includes:
obtaining urban graph data of a predetermined region, wherein the urban graph data includes a node set, an edge set, and a feature set, wherein the node set includes a central node corresponding to a predetermined urban entity in the predetermined region, the edge set includes a neighborhood corresponding to the central node, wherein the neighborhood includes other nodes in the node set that are connected to the central node via an edge, the neighborhood corresponds to one target region in the predetermined region, and predetermined urban entities corresponding to the nodes in the neighborhood are located in the target region, and the feature set includes node features of nodes in the node set;
partitioning the target region into at least two sub-regions to obtain a region partition set;
obtaining a regional feature of each sub-region by performing a feature aggregation on node features corresponding to all nodes located in the same sub-region; and
updating a node feature of the central node based on the regional features of the sub-regions in the region partition set to obtain target feature data.

According to a second aspect of the present disclosure, a model training method is provided. The model training method includes:
obtaining urban graph data of a predetermined region, wherein the urban graph data includes a node set, an edge set, and a feature set, wherein the node set includes a central node corresponding to a predetermined urban entity in the predetermined region, the edge set includes a neighborhood corresponding to the central node, the neighborhood including other nodes in the node set that are connected to the central node via an edge, and the feature set includes node features of nodes in the node set, and wherein the neighborhood corresponds to one target region in the predetermined region, and predetermined urban entities corresponding to the nodes in the neighborhood are located in the target region;
updating the node feature of each central node in the feature set based on the data generation method according the first aspect to obtain the target feature set, the target feature set including target feature data of each node in the node set; and
training a pre-constructed initial urban indicator generation model based on the node set, the edge set, and the target feature set to obtain a target model, wherein the target model is used for generating a score value of a predetermined urban indicator, and the predetermined urban indicator is an urban indicator associated with the predetermined urban entities.

According to a third aspect of the present disclosure, an electronic device is provided. The electronic device includes:
at least one processor; and
a memory in communication connection with the at least one processor,
wherein the memory is configured to store instructions executable by the at least one processor, and the instructions, when executed by the at least one processor, cause the at least one processor to perform the steps of the method according to the first aspect and the steps of the method according to the second aspect.

According to a fourth aspect of the present disclosure, a non-transitory computer-readable storage medium is provided. The non-transitory computer-readable storage medium has computer instructions stored thereon, wherein the computer instructions cause a computer to perform the steps of the method according to the first aspect and the steps of the method according to the second aspect.

### BRIEF DESCRIPTION OF THE DRAWINGS

The drawings are included to provide a better understanding of the present solution and are not to be construed as limiting the present disclosure, in which:

FIG. 1 is a flowchart of a data generation method according to an embodiment of the present disclosure;

FIG. 2 is a schematic diagram of sub-regions obtained after a partitioning of a target region according to an embodiment of the present disclosure;

FIG. 3 is another flowchart of a data generation method according to an embodiment of the present disclosure;

FIG. 4 is a flowchart of a model training method according to an embodiment of the present disclosure;

FIG. 5 is a schematic structural diagram of a data generation apparatus according to an embodiment of the present disclosure;

FIG. 6 is a schematic structural diagram of a first updating module according to an embodiment of the present disclosure;

FIG. 7 is a schematic structural diagram of an updating sub-module according to an embodiment of the present disclosure;

FIG. 8 is a schematic structural diagram of a model training apparatus according to the embodiment of the present disclosure; and

FIG. 9 is a block diagram of an electronic device for implementing a data generation method or a model training method according to an embodiment of the present disclosure.

### DETAILED DESCRIPTION

Exemplary embodiments of the present disclosure are described below with reference to the accompanying drawings, and various details, which are to be considered as merely exemplary, of embodiments of the present disclosure are included to assist understanding. Accordingly, those skilled in the art will recognize that various changes and modifications of the embodiments described herein can be made without departing from the scope and spirit of the present disclosure. Also, descriptions of well-known functions and constructions are omitted in the following description for clarity and conciseness.

Referring to FIG. 1, FIG. 1 is a schematic flowchart illustrating a data generation method according to an embodiment of the present disclosure. The data generation method includes the following steps S101 to S104.

At step S101, urban graph data of a predetermined region is obtained. The urban graph data includes a node set, an edge set, and a feature set. The node set includes a central node corresponding to a predetermined urban entity in the predetermined region. The edge set includes a neighborhood corresponding to the central node. The neighborhood includes other nodes in the node set that are connected to the central node via an edge. The neighborhood corresponds to one target region in the predetermined region, and predetermined urban entities corresponding to nodes in the neighborhood are located in the target region. The feature set includes node features of nodes in the node set.

At step S102, the target region is partitioned into at least two sub-regions to obtain a region partition set.

At step S103, a feature aggregation is performed on node features corresponding to all nodes located in a same sub-region to obtain a regional feature of each sub-region.

At step S104, a node feature of the central node is updated based on the regional features of the sub-regions in the region partition set to obtain target feature data.

A city is a complex system in which various connections (for example, a population mobility relationship between regions, a connection relationship between roads, etc.) exist between various urban entities, and considering these connections plays an important role in learning a representation of the urban entities. Thus, the city may be modeled as an urban graph, wherein a node on the graph represents a certain urban entity, and an edge on the graph represents a certain association between entities. A learning using Graph Neural Network (GNN) is performed on the urban graph to incorporate the relationships represented on the graph into the representation of the urban entities. However, unlike general research objects, the urban entities are distributed in a real geographic space, and spatial location is one of important features of the urban entities. Therefore, the modeling of the urban graph should not only describe a topological relationship between the nodes, but also reflect a spatial relationship between the urban entities.

Based on this, the present disclosure proposes a multi-dimensional and multi-scale comprehensive consideration of the spatial relationship between urban entities in learning the representation of the urban graph, which solves a problem of insufficient mining and utilization of spatial properties of the urban graph suffered by existing graph neural networks. The method can be applied to a wide range of downstream urban applications, such as regional prosperity prediction, crime rate prediction, and dangerous road identification.

Specifically, the predetermined region may be a large spatial range in which various urban entities are present. Specific urban entities in the predetermined region may be selected according to a specific scenario to build the node set. Then, the edge set is built based on the relationship between the nodes in the node set, and the feature set is built by obtaining relevant features of the urban entity corresponding to each node. For example, in a prosperity prediction scenario, when an urban prosperity prediction model needs to be trained, the predetermined urban entities corresponding to different nodes in the node set may be different regions within the predetermined region, and then connection edges between different nodes may be established according to the population mobility to generate the edge set. Specifically, when the migrant population between two nodes exceeds a predetermined value, a connection edge is established between the two nodes, and accordingly, when the migrant population between certain two nodes does not exceed the predetermined value, no connection edge is established between the two nodes. Then, each node is taken as a central node, and other nodes connected to each central node via a connection edge are determined to generate the neighborhood corresponding to the central node. It can be understood that each node in the node set may act as the central node, or as the other node connected to other central nodes. Thus, the edge set may be generated, and the edge set includes neighborhoods in one-to-one correspondence with nodes in the node set. Finally, relevant features of each node are analyzed individually to obtain a node feature of each node, thereby generating the feature set. Specifically, the node feature may include features that can reflect the urban prosperity, such as the quantity of entertainment venues, the quantity of shopping malls, the quantity of hospitals, and the quantity of universities within the urban region corresponding to the node. After obtaining the feature of each node, the feature set may be obtained.

For another example, when it is necessary to predict the population mobility relationship between regions, the urban graph data may be data of a population mobility graph. Specifically, a region may be taken as the node. That is, the predetermined urban entity corresponding to the node is the region, and the connection edge is established based on the human flow between regions, and the node features may be regional features of different regions. Accordingly, when it is necessary to identify a hazardous road section, the urban graph data may be data of a road network. At this time, an intersection may be taken as the node, the connection edge may be established based on a connection relationship between roads, and the node feature may be features of different road sections in a road network, e.g., a section length, real-time vehicle traffic data, and the like.

The following will further explain the data generation method by taking the prosperity prediction scenario as an example. Specifically, the node feature of each node in the urban graph data may be updated based on the method according to an embodiment of the present disclosure, and a pre-constructed model may be trained by using the urban graph data with updated node features, so as to obtain the model capable of predicting the urban prosperity based on urban graph data. That is, the data generation method can be used for generating training data of the prosperity prediction model.

Specifically, the predetermined region may be partitioned into a plurality of small regions according to a method of partitioning an administrative region in the related art, and each small region is taken as one node in the prosperity prediction scenario so as to obtain the node set. The central node is any one of nodes in the node set. In the present disclosure, taking updating the node feature of one central node based on the data generation method as an example, the specific implementation of the data generation method is explained and illustrated. G=(V, E, X) may be used for representing the urban graph data, where V={v₁, v₂, . . . , v_{N}} represents the node set formed by the predetermined urban entities in the predetermined region, E represents the edge set defined by a certain relationship between the urban entities (for example, the certain relationship may be based on migrant population between the nodes), and [symbol] (vᵢ)={vⱼ|(vᵢ, vⱼ)∈E} represents the neighborhood of the node vᵢ. X∈R^{N×d} represents a node feature matrix, where the i-th row represents a d-dimensional feature vector of the node vᵢ, that is, the i-th row is the node feature of the node vᵢ, and the d-dimensional vector may be a vector constructed according to features that can reflect the urban prosperity, such as the quantity of entertainment venues, the quantity of shopping malls, the quantity of hospitals, and the quantity of universities in the region corresponding to the node vᵢ. It can be understood that in different tasks, the node set V may represent different urban entities and the edge set E may represent different relationships.

Since a large quantity of nodes are included in the node set, the other nodes connected to the central node via a connection edge may be only part of the nodes in the node set, and different nodes in the neighborhood corresponding to the central node are distributed at different positions in the predetermined region, one target region may be determined according to a position of the central node and positions of the nodes in the neighborhood corresponding to the central node, wherein both the central node and the nodes in the neighborhood are located in the target region. It can be understood that the target region is part of the predetermined region.

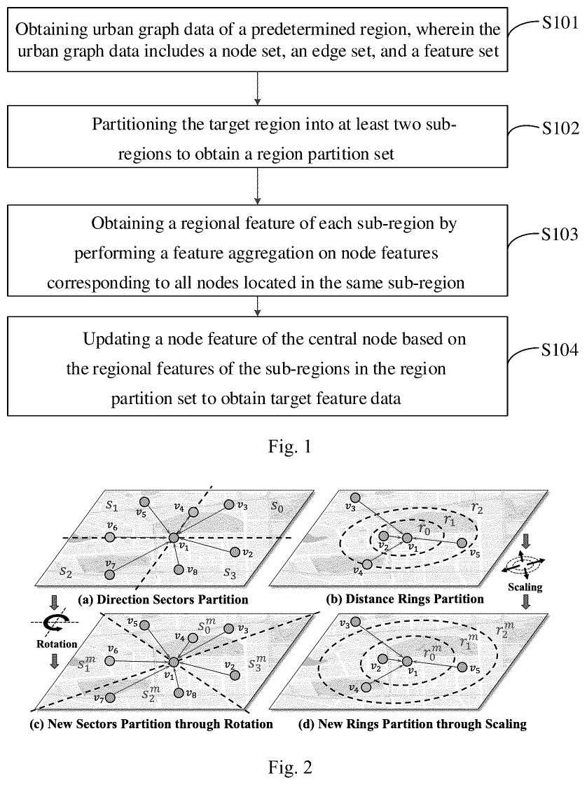

The target region being partitioned into the at least two sub-regions may specifically means that the target region is partitioned according to a method of direction-aware spatial partition. Specifically, for a certain central node vᵢ, the target region centered at vᵢ may be partitioned into a series of sectors [symbol] ={sₖ|k=0, 1, . . . , nₛ−1}, where nₛ represents the quantity of sectors as a result of the partition. Accordingly, neighbor nodes in the neighborhood [symbol] (vᵢ) may be assigned to various sectors, and the neighbor nodes distributed in different sectors may be redefined as different direction-aware neighborhoods { [symbol] ₛ_{ₖ}(vᵢ)|k=0, 1, . . . , nₛ−1}, which satisfy Uₖ₌₀ⁿ^{ₛ}⁻¹ [symbol] ₛ_{ₖ}(vᵢ)= [symbol] (vᵢ). Under such partitioning, different direction-aware neighborhoods (sectors) may be regarded as different sub-regions, representing different relative spatial relationships between the neighbor nodes and the central node. FIG. 2(a) shows the direction-aware spatial partition by taking the case that the central node is v₁ as an example. After the region partition is performed, the node features of the nodes in each sub-region are aggregated separately. In this way, at least two regional features in one-to-one correspondence with the at least two sub-regions may be obtained, and different regional features of the at least two regional features represent features of neighbor nodes at different orientations relative to the central node. Therefore, compared with a direct aggregation of the node features of all nodes in the neighborhood corresponding to the central node, the solution in the present disclosure updates the node feature of the central node by using the regional features of the sub-regions in the region partition set to obtain the target feature data, thereby retaining the orientation features of various neighbor nodes in the neighborhood, which is beneficial to mining semantic differences brought by different spatial relationships in a same topological structure, and further improving the quality of the generated target feature data.

In addition, a relative position relationship between the urban entities includes not only different directions, but also different distances. Therefore, in another embodiment of the present disclosure, the target region may also be partitioned according to a method of distance-aware spatial partition. Specifically, as shown in FIG. 2(b), in the present embodiment, the target region corresponding to the neighborhood is partitioned in a distance dimension. Specifically, a distance segmentation may be defined firstly, such as [<2.5 km, 2.5 to 5 km, >2.5 km]. According to such distance segmentation, the target region centered at vᵢ may be partitioned into a series of rings [symbol] ={rₖ|k=0, 1, . . . , nᵣ−₁}, where nᵣ represents the quantity of rings. Similarly, the neighborhood [symbol] (vᵢ) of vᵢ may be partitioned into a series of distance-aware neighborhoods { [symbol] ᵣ_{ₖ}(vᵢ)|k=0, 1, . . . , nᵣ−1}, which satisfy Uₖ₌₀ⁿ^{ᵣ}⁻¹ [symbol] ᵣ_{ₖ}(vᵢ)= [symbol] (vᵢ). After the region partition is performed, the node features of the nodes in each sub-region are aggregated separately. In this way, at least two regional features in one-to-one correspondence with the at least two sub-regions may be obtained, and different regional features of the at least two regional features represent features of neighbor nodes at different distances to the central node. Therefore, compared with a direct aggregation of the node features of all nodes in the neighborhood corresponding to the central node, the solution in the present disclosure updates the node feature of the central node by using the regional features of the sub-regions in the region partition set to obtain the target feature data, thereby retaining the distance features of various neighbor nodes in the neighborhood, which is beneficial to mining semantic differences brought by different spatial relationships in a same topological structure, and further improving the quality of the generated target feature data.

It can be understood that, the feature aggregation of the node features corresponding to all nodes located in the same sub-region may specifically mean that, according to a feature aggregation method in the related art, the node features of the nodes located in the same sub-region are aggregated, and the aggregation result is used as the regional feature of the sub-region.

The node feature of the central node being updated based on the regional features of the sub-regions in the region partition set may specifically mean that the regional features of the sub-regions in the region partition set and the node feature of the central node are fused to obtain the target feature data. For example, the regional features of the sub-regions in the region partition set and the node feature of the central node may be simply concatenated to obtain the target feature data Alternatively, one feature vector may be constructed based on the regional features of the sub-regions in the region partition set and the node feature of the central node, to obtain the target feature data.

In the implementation, the target region is partitioned into at least two sub-regions, and the node features corresponding to all nodes located in the same sub-region are aggregated, to obtain the regional feature of each sub-region. In this way, the features of nodes in different spatial positions can be aggregated separately, thereby ensuring that spatial information of the urban entities can be fully considered in the process of generating the target feature data, so as to mine semantic differences brought by different spatial relationships in the same topological structure, and further improve the quality of the generated target feature data.

Optionally, the target region being partitioned into the at least two sub-regions to obtain the region partition set includes: performing an M-head region partition on the target region based on a target partition manner to obtain the region partition set. The region partition set includes M region partition subsets in one-to-one correspondence with M heads of the M-head region partition. Each of the M region partition subsets includes at least two sub-regions. Partition parameters corresponding to different heads of the M-head region partition are different, where M is an integer greater than 1, and the partition parameters include at least one of: a position parameter of a partition line in the target region, or a distance parameter between different partition lines.

The partition line is a boundary line between two adjacent sub-regions, i.e., the partition line is a separation line separating two adjacent sub-regions.

Specifically, following special cases are considered: some neighbor nodes in the neighborhood are distributed on the boundary between the two sub-regions, and the sub-region to which the neighbor nodes belong cannot be determined. For example, for the sector partition in FIG. 2(a), a node v₆ is distributed on the boundary between two sectors s₀ and s₁, indicating that such a single sector partition is not capable of fully describing diverse spatial relationships. Similar situations also occur in the distance-ring partition, e.g., the node v₄ in FIG. 2(b). Therefore, the present disclosure further proposes a strategy of rotation-scaling multi-head partition, wherein the multi-head partition is performed in both the direction dimension and the distance dimension, such that different partitions complement each other. The present disclosure introduces two operations: namely, sector rotation and ring scaling, so as to realize the multi-head spatial partition and the modeling of various spatial relationships. Specifically, as shown in FIG. 2(a) and FIG. 2(c), through rotating the boundary of a sector by an angle (e.g., 45 degrees), partition of another group of sectors may be achieved, and then the neighbor nodes may be reassigned to the newly partitioned sectors to form a new group of direction-aware neighborhoods. With such multi-head partition, a formal representation of the sectors is updated to [symbol] ^{m}={sₖ_{^{m}}|k=0, 1, . . . , nₛ−1}, and the representation of the direction-aware neighborhoods is updated to { [symbol] sₖ_{^{m}}(vᵢ)|k=0, 1, . . . , nₛ−1}, where m=1, 2, . . . , Mₛ, Mₛ represents the quantity of heads, that is, Mₛ-head partition is performed.

It can be understood that { [symbol] sₖ_{^{m}}(vᵢ)|k=0, 1, . . . , nₛ−1} includes the partition results of the Mₛ-head partition, and all the sub-regions resulting from the Mₛ-head partition may be taken as the sub-regions in the region partition set. Thus, the node features may be aggregated once based on the partition result of each head, so that the regional features of the sub-regions in the partition result of each head of the Mₛ-head partition may be obtained, and the node feature of the central node may be updated based on the regional features of the sub-regions in the partition result of each head of the Mₛ-head partition.

Similarly, in the distance dimension, as shown in FIG. 2(b) and FIG. 2(d), the boundary of the ring is scaled to obtain a new partition. A formal representation of various rings is also updated to [symbol] ^{m}={rₖ^{m}|k=0, 1, . . . , nᵣ−1}, and a formal representation of distance-aware neighborhoods is also updated to { [symbol] rₖ_{^{m}}(vᵢ)|k=0, 1, . . . , nᵣ−1}, where m=1, 2, . . . , Mᵣ. In this way, different groups of spatial partition can complementarily represent geographical position distributions of neighbor nodes, and a problem that the single partition is not comprehensive and inaccurate can be solved. In the spatial partition, since the central node vᵢ itself does not belong to any sector or ring, vᵢ can be regarded as an additional spatial group, that is, [symbol] sₙ_{ₛ}_{^{m}}(vᵢ)= [symbol] rₙ_{ᵣ}_{^{m}}(vᵢ)={vᵢ}.

In the implementation, the M-head region partition is performed on the target region based on the target partition manner to obtain the region partition set. In this way, different partitions can complement each other, thus improving the effect of the region partition.

Optionally, the target partition manner includes a first sub-partition manner and a second sub-partition manner. An i-th head of the M-head region partition performed on the target region based on the target partition manner includes:
partitioning the target region into at least two fan-shaped sub-regions centered at a target position point based on the first sub-partition manner to obtain a first region group, wherein the first region group includes the at least two fan-shaped sub-regions and a central sub-region, and the central sub-region is the region where the target position point is located; and
partitioning the target region into at least two ring-shaped sub-regions centered at the target position point based on the second sub-partition manner to obtain a second region group, wherein the second region group includes the at least two ring-shaped sub-regions and the central sub-region,
wherein the target position point is a position point of the predetermined urban entity corresponding to the central node in the target region, an i-th region partition subset includes the first region group and the second region group, the i-th region partition subset is one of the M region partition subsets that corresponds to the i-th head, and the position parameter of the first sub-partition manner is different for different heads of the M-head region partition, and the distance parameter of the second sub-partition manner is different for different heads of the M-head region partition.

Specifically, the first sub-partition manner may be the direction-aware spatial partition. The second sub-partition manner may be the distance-aware spatial partition.

The position parameters of the first sub-partition manner being different for different heads may specifically mean: each time regions are re-partitioned, the partition line used in the previous partition is rotated by a predetermined angle, with the central node being a center of rotation, wherein the predetermined angle may be 5 degrees, 10 degrees, and the like.

The distance parameters of the second sub-partition manner being different for different heads may mean: the distance between each partition line and the central node is different for different heads.

The first region group may be a set of sub-regions obtained by partitioning the target region once based on the first sub-partition manner, and correspondingly, the second region group may be a set of sub-regions obtained by partitioning the target region once based on the second sub-partition manner.

It can be understood that, since the target partition manner includes the first sub-partition manner and the second sub-partition manner, each head includes the two partition manners, that is, each head includes two partition results. It can be understood that after the M-head region partition, M first region groups and M second region groups may be obtained, and each region partition subset includes one first region group and one second region group. The region partition set includes M first region groups and M second region groups. In one embodiment of the present disclosure, the region partition set may include aforementioned { [symbol] ₛ_{ₖ}_{^{m}}(vᵢ)|k=0, 1, . . . , nₛ−1} and [symbol] ^{m}={rₖ^{m}|k=0, 1, . . . , nᵣ−1}, and at this time, Mₛ=Mᵣ=M.

In the implementation, since each head includes a partition result obtained based on the first sub-partition manner and a partition result obtained based on the second sub-partition manner, the manner of partitioning the target region can be further enriched, so as to further enrich contents in the region partition set, thereby facilitating the improvement of the effect of partitioning the target region.

Optionally, the node feature of the central node being updated based on the regional features of the sub-regions in the region partition set to obtain the target feature data includes:
fusing the regional features of the sub-regions in each first region group to obtain M first feature data in one-to-one correspondence with the M region partition subsets;
fusing the regional features of the sub-regions in each second region group to obtain M second feature data in one-to-one correspondence with the M region partition subsets; and
updating the node feature of the central node based on the M first feature data and the M second feature data to obtain the target feature data.

It will be understood that after the partition of the target region, the region partition set may include M first region groups and M second region groups. Then, for each sub-region in various region groups (the first region group and the second region group) of the region partition set, the node features corresponding to all nodes located in the same sub-region are aggregated to obtain the regional feature of each sub-region.

Specifically, since one first region group includes at least two sub-regions obtained by one partition, and the at least two sub-regions collectively form the target region, after the regional feature of each sub-region in the first region group is obtained based on the aforementioned feature aggregation process, the regional features of all sub-regions in the first region group may be further fused, to obtain the first feature data which is capable of representing the node features of nodes at different spatial positions in the neighborhood.

Correspondingly, since one second region group includes at least two sub-regions obtained by one partition, and the at least two sub-regions collectively form the target region, after the regional feature of each sub-region in the second region group is obtained based on the aforementioned feature aggregation process, the regional features of all sub-regions in the second region group may be further fused, to obtain the second feature data which is capable of representing the node features of nodes at different spatial positions in the neighborhood.

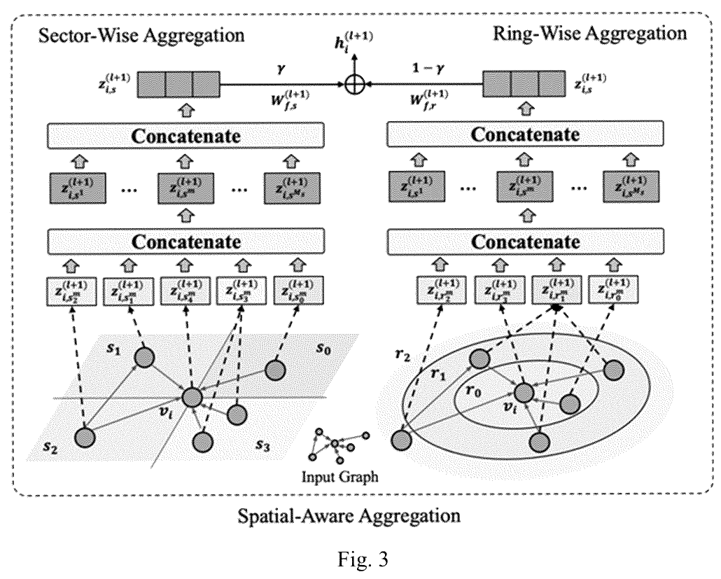

The fusion of the regional features may specifically be performed by adopting a fusion method commonly used in the related art. For example, the regional features of different sub-regions may be concatenated, or a feature matrix may be constructed based on the regional features of different sub-regions. For example, as shown in FIG. 3, in one embodiment of the present disclosure, taking the partition in a direction dimension as an example, for direction-aware neighborhoods { [symbol] sₖ_{^{m}}(vᵢ)|k=0, 1, . . . , nₛ} (including the central node itself) of an M^{th} head, the node features of each neighborhood [symbol] sₖ_{^{m}}(vᵢ) may be aggregated by using graph convolution:

$${z}_{i , {s}_{k}^{m}}^{( l + 1 )} = {Σ}_{j ∈ {N}_{{s}_{k}^{m}}^{m}} \frac{1}{\sqrt{\vert N ( {v}_{i} ) \vert \cdot \vert N ( {v}_{j} ) \vert}} {h}_{j}^{( 1 )} {W}_{{s}_{k}^{m}}^{( l )} ,$$

where the graph convolution may include a plurality of layers of network connected in sequence, an input of each layer of network is an output of the previous layer of network, and an input of a first layer of network is the direction-aware neighborhoods { [symbol] sₖ_{^{m}}(vᵢ)|k=0, 1, . . . , nₛ}. z_{i,s}_{ₖ}_{^{m}}^{(l+1)} represents information aggregated from a sector sₖ by the (l+1)-th layer of network, which is taken as a representation vector of the sector sₖ in the m-th head; hⱼ^{(l)} represents the feature of a neighbor node vⱼ that is outputted by the l-th layer of network (hⱼ⁽⁰⁾=xⱼ); and Wₛ_{ₖ}_{^{m}}^{(l)} denotes a trainable transformation matrix, which is used for extracting useful information from the features of the neighbor nodes. Similarly, as shown in FIG. 3, in the distance dimension, nodes in each ring may be aggregated separately by using the following equation:

$${z}_{i , {r}_{k}^{m}}^{( l + 1 )} = {Σ}_{j ∈ {N}_{{r}_{k}^{m}} ( {v}_{i} )} \frac{1}{\sqrt{\vert N ( {v}_{i} ) \vert \cdot \vert N ( {v}_{j} ) \vert}} {h}_{j}^{( l )} {W}_{{r}_{k}^{m}}^{( l )} ,$$

where z_{i,r}_{ₖ}_{^{m}}^{(l+1)} represents a representation vector of a ring rₖ in the m-th head, and Wᵣ_{ₖ}_{^{m}}^{(l)} represents another transformation matrix, which is used for learning node features of neighbor nodes at different distances.

In the implementation, the node feature of the central node is updated based on the M first feature data and the M second feature data. In this way, since the partition results of the M-head region partition are fused in the process of updating the node feature of the central node, and partition results of different heads can complement each other, the semantic differences brought by different spatial relationships in the same topological structure can be better mined, thereby improving the quality of the generated target feature data.

Optionally, the fusing the regional features of the sub-regions in each first region group to obtain the M first feature data includes:
performing a feature concatenation on the regional features of the sub-regions in each first region group to obtain the M first feature data.

Specifically, for the representation of each sector/ring region in the m-th head, different from the conventional graph neural network that fuses representations of neighborhoods through summing or averaging (because the features of neighbor nodes with different spatial distributions would be mixed when this method is adopted), the embodiment of the present disclosure performs the fusion by using a manner of concatenation. In this way, features at different concatenating positions of the first feature data resulting from the concatenation represent the features corresponding to different spatial positions. Thus, it can be avoided that the first feature data resulting from the fusion mixes features of neighbor nodes spatially distributed differently.

As shown in FIG. 3, in one embodiment of the present disclosure, the process of performing a feature concatenation on the regional features of the sub-regions in each first region group to obtain the M first feature data can be implemented specifically by using the following equation:

$${z}_{i , {s}^{m}}^{( l + 1 )} = {\vert \vert}_{k = 0}^{{n}_{s}} {z}_{i , {s}_{k}^{m}}^{( l + 1 )} ,$$

z_{i,s}_{^{m}}^{(l+1)} is the representation of the neighborhood in the direction dimension in the m-th head, that is, z_{i,s}_{^{m}}^{(l+1)} represents a vector representation of one first region group after fusion.

In the implementation, the regional features of the sub-regions in each first region group are concatenated to obtain the M first feature data. In this way, it can be avoided that the first feature data resulting from the fusion mixes features of neighbor nodes spatially distributed differently.

Optionally, the fusing the regional features of the sub-regions in each second region group to obtain the M second feature data includes:
performing a feature concatenation on the regional features of the sub-regions in each second region group to obtain the M second feature data.

As shown in FIG. 3, in one embodiment of the present disclosure, the process of performing a feature concatenation on the regional features of the sub-regions in each second region group to obtain the M second feature data can be implemented specifically by using the following equation:

$${z}_{i , {r}^{m}}^{( l + 1 )} = {\vert \vert}_{k = 0}^{{n}_{r}} {z}_{i , {r}_{k}^{m}}^{( l + 1 )} ,$$

where z_{i,r}_{^{m}}^{(l+1)} represents the representation of the neighborhood in the distance dimension in the m-th head, that is, z_{i,r}_{^{m}}^{(l+1)} represents a vector representation of one second region group after fusion.

In the implementation, the regional features of the sub-regions in each second region group are concatenated to obtain the M second feature data. In this way, it can be avoided that the second feature data resulting from the fusion mixes features of neighbor nodes spatially distributed differently.

Optionally, the updating the node feature of the central node based on the M first feature data and the M second feature data to obtain the target feature data includes:
performing a feature concatenation on the M first feature data to obtain a first updated feature;
performing a feature concatenation on the M second feature data to obtain a second updated feature; and
performing a weighted summation on the first updated feature and the second updated feature to obtain the target feature data.

As shown in FIG. 3, in one embodiment of the present disclosure, the process of performing a feature concatenation on the M first feature data to obtain the first updated feature can be implemented by the following equation:

$${z}_{i , s}^{( l + 1 )} = {\vert \vert}_{m = 1}^{{M}_{s}} {z}_{i , {s}^{m}}^{( l + 1 )} ,$$

where z_{i,s}^{(l+1)} represents the first updated feature, that is, the M first feature data resulting from the M-head partition are concatenated in sequence, and z_{i,s}^{(l+1)} represents a vector representation of the M first region groups after fusion.

At the same time, the process of performing a feature concatenation on the M second feature data to obtain the second updated feature can be implemented by the following equation:

$${z}_{i , r}^{( l + 1 )} = {\vert \vert}_{m = 1}^{{M}_{r}} {z}_{i , {r}^{m}}^{( l + 1 )} ,$$

where z_{i,r}^{(l+1)} represents the second updated feature, that is, the M second feature data resulting from the M-head partition are concatenated in sequence, and z_{i,r}^{(l+1)} represents a vector representation of the M second region groups after fusion.

The process of performing the weighted summation on the first updated feature and the second updated feature to obtain the target feature data can be implemented by the following equation:

$${h}_{i}^{( l + 1 )} = γ {z}_{i , s}^{( l + 1 )} {W}_{f , s}^{( l + 1 )} + ( 1 - γ ) {z}_{i , r}^{( l + 1 )} {W}_{f , r}^{( l + 1 )} ,$$

where hᵢ^{(l+1)} represents a representation vector of the central node vᵢ that is outputted by the (l+1)-th layer of network, i.e., the target feature data. W_{f,s}^{(l+1)} and W_{f,r}^{(l+1)} are two learnable transformation matrices that map the representation vectors of two spatial dimensions to the same space. γ∈(0,1) is also a trainable parameter that learns how to assign the importance of the two spatial dimensions according to the target task.

In the implementation, the M first feature data are concatenated to obtain the first updated feature; and the M second feature data are concatenated to obtain the second updated feature. In this way, in the aggregation process, the features of the neighboring nodes in different spatial groups are not mixed, and the spatial information of different neighbor nodes can be retained in the representation of the central node.

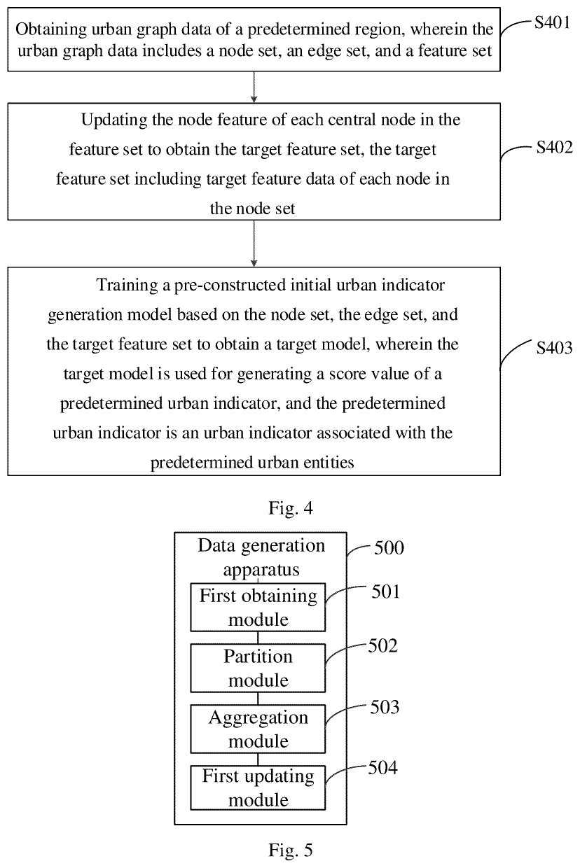

Referring to FIG. 4, FIG. 4 shows a model training method according to an embodiment of the present disclosure. The model training method includes the following steps S401 to S403.

At step S401, urban graph data is obtained. The urban graph data includes a node set, an edge set, and a feature set. The node set includes a central node corresponding to a predetermined urban entity in the predetermined region. The edge set includes a neighborhood corresponding to the central node. The neighborhood includes other nodes in the node set that are connected to the central node via an edge. The feature set includes a node feature of the central node. The neighborhood corresponds to one target region in the predetermined region, and predetermined urban entities corresponding to nodes in the neighborhood are located in the target region.

At step S402, the node feature of each central node in the feature set is updated based on the data generation method according to the embodiment described above, to obtain a target feature set. The target feature set includes target feature data of each node in the node set.

At step S403, a pre-constructed initial urban indicator generation model is trained based on the node set, the edge set, and the target feature set to obtain a target model. The target model is used for generating a score value of a predetermined urban indicator. The predetermined urban indicator is an urban indicator associated with the predetermined urban entities.

The predetermined urban indicator may be any of various urban indicators common in the related art. For example, the predetermined urban indicator may be an urban prosperity indicator, urban population mobility, an urban crime rate indicator, and the like. When the predetermined urban indicator is the urban prosperity indicator, the initial urban indicator generation model may be the prosperity prediction model according to the embodiment described above. Then, the urban graph data may be constructed based on the method according to the embodiment described above, and the node feature of each central node in the feature set may be updated based on the data generation method according to the embodiment described above, to obtain the target feature set. Then, the pre-constructed initial urban indicator generation model is trained based on the node set, the edge set, and the target feature set to obtain the target model. At this time, the score value is the urban prosperity, that is, the trained target model may be based on the urban prosperity corresponding to the urban graph data.

Correspondingly, when the predetermined urban indicator is the urban population mobility, the urban graph data may be constructed based on the method according to the embodiment described above, and the processes of node feature updating and model training may be repeated to obtain the target model capable of predicting the urban population mobility.

The initial urban indicator generation model may include the Graph Neural Network (GNN) according to the embodiment described above and a classifier. The classifier may be a classifier for scenarios in the neural network model in the related art. The urban graph data may be input into the initial urban indicator generation model. The Graph Neural Network (GNN) generates the target feature set based on the urban graph data. Then the classifier performs the prediction based on the target feature set, the node set, and the edge set to obtain the corresponding score value. In the training process, the GNN may optimize the aforementioned trainable parameters to improve the quality of the target feature data output by the GNN.

In the specific training process, different loss functions may be adopted to optimize the network in different downstream tasks. For example, for a node regression task (such as regional prosperity prediction), a minimum mean square error (MAE) may be used as a loss function to optimize the network. For a node classification task (such as dangerous road section identification), a cross entropy loss function may be used for training the model.

In one embodiment of the present disclosure, the target model is the prosperity prediction model. The node feature of each central node in the feature set being updated based on the data generation method according to the embodiment described above to obtain the target feature set includes:
inputting the urban graph data into the initial urban indicator generation model, and updating the node feature of each central node in the feature set by using the GNN in the initial urban indicator generation model based on the method according to the embodiment described above, to obtain the target feature set.

The pre-constructed initial urban indicator generation model being trained based on the node set, the edge set, and the target feature set to obtain the target model includes:
inputting the node set, the edge set, and the target feature set into the classifier of the initial urban indicator generation model for prediction, to obtain a predicted score value; and
constructing a loss function based on the predicted score value and a predetermined label value, and updating parameters of the GNN based on the loss function to obtain the target model, wherein the predetermined label value may be a predetermined prosperity of the predetermined region corresponding to the urban graph data.

In the embodiment of the present disclosure, the GNN can fully consider spatial distribution information of the urban entities in the processes of feature aggregation and message passing, which improves the learning ability of the GNN on the urban graph. Specifically, first, compared to conventional GNNs, the GNN according to the embodiment of the present disclosure can fully model the spatial information of the urban entities and mine the semantic differences brought by different spatial relationships in the same topological structure. Second, in contrast to the direct use of latitude and longitude as the node features, the method according to the embodiment of the present disclosure can capture the relative position relationship between the urban entities. Third, compared to simply assigning greater aggregation weights to closer neighbor nodes, different feature transformations are set for different spatial groups according to the embodiment of the present disclosure, allowing the model to adaptively learn the relationship between downstream tasks and spatial positions, which is more versatile. Fourth, both the spatial dimension of direction and the spatial dimension of distance are considered according to the embodiment of the present disclosure, so as to more comprehensively portray the relative position relationship between the urban entities. Fifth, the multi-head spatial partition through rotation and scaling operations enables the modeling of more complex and diverse spatial relationships, and overcomes a shortcoming of single partition that is overly dependent on a prior knowledge.

Referring to FIG. 5, FIG. 5 is a schematic structural diagram of a data generation apparatus 500 according to an embodiment of the present disclosure. The data generation apparatus 500 includes a first obtaining module 501, a partition module 502, an aggregation module 503, and a first updating module 504.

The first obtaining module 501 is configured to obtain urban graph data of a predetermined region. The urban graph data includes a node set, an edge set, and a feature set. The node set includes a central node corresponding to a predetermined urban entity in the predetermined region. The edge set includes a neighborhood corresponding to the central node. The neighborhood includes other nodes in the node set that are connected to the central node via an edge. The neighborhood corresponds to one target region in the predetermined region, and predetermined urban entities corresponding to the nodes in the neighborhood are located in the target region. The feature set includes node features of nodes in the node set.

The partition module 502 is configured to partition the target region into at least two sub-regions to obtain a region partition set.

The aggregation module 503 is configured to obtain a regional feature of each sub-region by performing a feature aggregation on node features corresponding to all nodes located in the same sub-region.

The first updating module 504 is configured to update a node feature of the central node based on the regional features of the sub-regions in the region partition set to obtain target feature data.

Optionally, the partition module 502 is specifically configured to perform an M-head region partition on the target region based on a target partition manner to obtain the region partition set. The region partition set includes M region partition subsets in one-to-one correspondence with M heads of the M-head region partition. Each of the M region partition subsets includes at least two sub-regions. Partition parameters corresponding to different heads of the M-head region partition are different, where M is an integer greater than 1, and the partition parameters include at least one of: a position parameter of a partition line in the target region, or a distance parameter between different partition lines.

Optionally, the target partition mode includes a first sub-partition manner and a second sub-partition manner, and an i-th head of the M-head region partition performed on the target region based on the target partition manner includes:
partitioning the target region into at least two fan-shaped sub-regions centered at a target position point based on the first sub-partition manner to obtain a first region group, wherein the first region group includes the at least two fan-shaped sub-regions and a central sub-region, and the central sub-region is the region where the target position point is located; and
partitioning the target region into at least two ring-shaped sub-regions centered at the target position point based on the second sub-partition manner to obtain a second region group, wherein the second region group includes the at least two ring-shaped sub-regions and the central sub-region,
wherein the target position point is the position point of the predetermined urban entity corresponding to the central node in the target region, an i-th region partition subset includes the first region group and the second region group, the i-th region partition subset is the region partition subset corresponding to the i-th head among the M region partition subsets, and the position parameter of the first sub-partition manner is different for different heads of the M-head region partition, and the distance parameter of the second sub-partition manner is different for different heads of the M-head region partition.

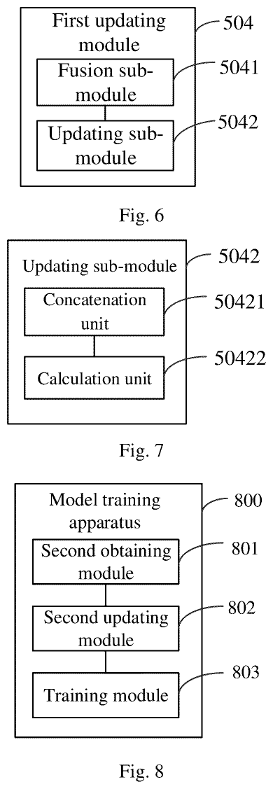

Optionally, referring to FIG. 6, the first updating module 504 includes a fusion sub-module 5041 and an updating sub-module 5042.

The fusion sub-module 5041 is configured to fuse the regional features of the sub-regions in each first region group to obtain M first feature data in one-to-one correspondence with the M region partition subsets.

The fusion sub-module 5041 is further configured to fuse the regional features of the sub-regions in each second region group to obtain M second feature data in one-to-one correspondence with the M region partition subsets.

The updating sub-module 5042 is configured to update the node feature of the central node based on the M first feature data and the M second feature data to obtain the target feature data.

Optionally, the fusion sub-module 5041 is specifically configured to perform a feature concatenation on the regional features of the sub-regions in each first region group to obtain the M first feature data.

Optionally, the fusion sub-module 5041 is specifically configured to perform a feature concatenation on the regional features of the sub-regions in each second region group to obtain the M second feature data.

Optionally, referring to FIG. 7, the updating sub-module 5042 includes a concatenation unit 50421 and a calculation unit 50422.

The concatenation unit 50421 is configured to perform a feature concatenation on the M first feature data to obtain a first updated feature.

The concatenation unit 50421 is further configured to perform a feature concatenation on the M second feature data to obtain a second updated feature.

The calculation unit 50422 is configured to perform a weighted summation on the first updated feature and the second updated feature to obtain the target feature data.

It should be noted that the data generation apparatus 500 provided by the present embodiment can implement all the technical solutions of the embodiments of the data generation method, and therefore can realize at least all the technical effects described above, which are not described in detail herein.

Referring to FIG. 8, FIG. 8 is a schematic structural diagram of a model training apparatus 800 according to an embodiment of the present disclosure. The model training apparatus 800 includes a second obtaining module 801, a second updating module 802, and a training module 803.

The second obtaining module 801 is configured to obtain urban graph data. The urban graph data includes a node set, an edge set, and a feature set. The node set includes a central node corresponding to a predetermined urban entity in the predetermined region. The edge set includes a neighborhood corresponding to the central node. The neighborhood includes other nodes in the node set that are connected to the central node via an edge. The feature set includes a node feature of the central node. The neighborhood corresponds to one target region in the predetermined region, and predetermined urban entities corresponding to nodes in the neighborhood are located in the target region.

The second updating module 802 is configured to update the node feature of each central node in the feature set based on the data generation method according to the embodiment described above to obtain a target feature set. The target feature set includes target feature data of each node in the node set.

The training module 803 is configured to train a pre-constructed initial urban indicator generation model based on the node set, the edge set, and the target feature set to obtain a target model. The target model is used for generating a score value of a predetermined urban indicator. The predetermined urban indicator is an urban indicator associated with the predetermined urban entities.

It should be noted that the model training apparatus 800 provided by the present embodiment can implement all the technical solutions of the embodiments of the model training method, and therefore can realize at least all the technical effects described above, which are not described in detail herein.

The obtaining, storage, and application of the use's personal information involved in the technical solutions of the present disclosure are in compliance with relevant laws and regulations, and do not violate public order and morality.

According to embodiments of the present disclosure, the present disclosure also provides an electronic device, a readable storage medium, and a computer program product.

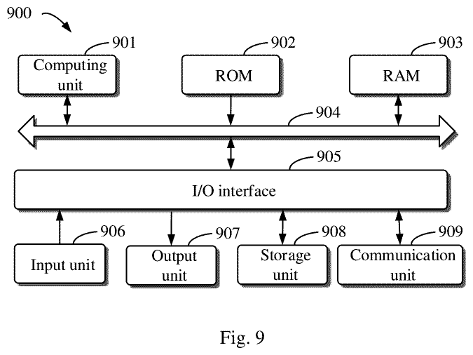

FIG. 9 illustrates a schematic block diagram of an exemplary electronic device 900 that can be used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may also represent various forms of mobile devices, such as a personal digital processor, a cellular phone, a smart phone, a wearable device, and other similar computing devices. Components shown herein, their connections and relationships as well as their functions are merely examples, and are not intended to limit the implementation of the present disclosure described and/or required herein.

As shown in FIG. 9, the electronic device 900 includes a computing unit 901, which may perform various appropriate actions and processes in accordance with a computer program stored in a read-only memory (ROM) 902 or loaded from a storage unit 908 into a random access memory (RAM) 903. In the RAM 903, various programs and data required for operation of the electronic device 900 may also be stored. The computing unit 901, the ROM 902, and the RAM 903 are connected to each other through a bus 904. An input/output (I/O) interface 905 is also connected to the bus 904.

A plurality of components in the electronic device 900 are connected to the I/O interface 905. The plurality of components include: an input unit 906 such as a keyboard, and a mouse; an output unit 907 such as various types of displays, and speakers; a storage unit 908 such as a magnetic disk and an optical disc; and a communication unit 909 such as a network card, a modem, and a wireless communication transceiver. The communication unit 909 allows the electronic device 900 to exchange information/data with other devices through a computer network such as the Internet and/or various telecommunication networks.

The computing unit 901 may be a variety of general-purpose and/or dedicated processing components with processing and computing capabilities. Some examples of the computing unit 901 include, but are not limited to, a central processing unit (CPU), a graphics processing unit (GPU), various specialized artificial intelligence (AI) computing chips, various computing units running machine-learning model algorithms, a digital signal processor (DSP), and any appropriate processors, controllers, microcontrollers, and the like. The computing unit 901 performs various methods and processes described above, such as the data generation method or the model training method. For example, in some embodiments, the data generation method or the model training method may be implemented as a computer software program tangibly contained in a machine-readable medium, such as the storage unit 908. In some embodiments, part or all of the computer program may be loaded and/or installed on the electronic device 900 via the ROM 902 and/or the communication unit 909. When the computer program is loaded into the RAM 903 and executed by the computing unit 901, one or more steps of the data generation method or the model training method are performed. Optionally, in other embodiments, the computing unit 901 may be configured to perform the data generation method or the model training method in any other suitable manner (e.g., by means of firmware).

Various implementations of the system and technique described hereinabove may be implemented in a digital electronic circuitry system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software, and/or combinations thereof. These various implementations may include: being implemented in one or more computer programs that are executable and/or interpreted on a programmable system including at least one programmable processor. The programmable processor may be a dedicated or general-purpose programmable processor that may receive data and instructions from a storage system, at least one input device and at least one output device, and transmit the data and instructions to the storage system, the at least one input device, and the at least one output device.

Program codes for implementing the methods of the present disclosure may be written in one programming language or a combination of programming languages. The program codes may be provided to a processor or controller of a general purpose computer, a dedicated computer, or other programmable data processing devices, such that the program codes, when executed by a processor or controller, enable functions/operations specified in the flow chart and/or block diagram to be implemented. The program code may be executed entirely on a machine, partially on the machine, as a stand-alone software package partially on the machine and partially on a remote machine, or entirely on a remote machine or server.

In the context of the present disclosure, a machine-readable medium may be a tangible medium, which may contain or store a program for use by or used in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection based on one or more wires, a portable computer disk, a hard disk, an RAM, an ROM, an EPROM or a flash memory, an optical fiber, a CD-ROM, an optical storage device, a magnetic storage device, or any suitable combination thereof.

In order to provide interactions with the user, the systems and technologies described herein may be implemented on a computer having: a display device (for example, a cathode ray tube (CRT) or a liquid crystal display (LCD) monitor) for displaying information to the user; and a keyboard and a pointing device (such as a mouse or trackball) through which the user may provide input to the computer. Other kinds of devices may also be used to allow for interactions with the user; for example, the feedback provided to the user may be any form of sensory feedback (e.g., visual feedback, auditory feedback, or haptic feedback); and input from the user may be received in any form (including acoustic input, voice input, or tactile input).

The systems and technologies described herein may be implemented in a computing system that includes back-end components (for example, as a data server), a computing system that includes middleware components (for example, an application server), or a computing system that includes front-end components (for example, a user computer with a graphical user interface or a web browser, through which the user may interact with the implementation of the systems and technologies described herein), or a computing system including any combination of the back-end components, the middleware components, or the front-end components. The components of the system may be interconnected by digital data communication in any form or medium (e.g., a communication network). Examples of the communication network include: a local area network (LAN), a wide area network (WAN), and the Internet.

Computer systems may include a client and a server. The client and the server are generally remote from each other and typically interact through the communication network. A client-server relationship is generated by computer programs running on respective computers and having a client-server relationship with each other. The server can be a cloud server, a server of a distributed system, or a server in combination with block chain.

It should be understood that various forms of processes shown above may be reordered, added, or deleted. For example, the steps described in the present disclosure may be executed in parallel, sequentially, or in different orders. As long as the desired results of the technical solution disclosed herein can be achieved, there is no limitation in this regard.

The foregoing specific implementations do not constitute a limitation on the scope of the present disclosure. It should be understood by those skilled in the art that various modifications, combinations, sub-combinations, and substitutions may be made according to design requirements and other factors. Any modification, equivalent replacement, and improvement made within the spirit and principle of the present disclosure shall be included in the scope of the present disclosure.

What is claimed is:

1. A data generation method comprising:
obtaining urban graph data of a predetermined region, wherein the urban graph data comprises a node set, an edge set, and a feature set, the node set comprises a central node corresponding to a predetermined urban entity in the predetermined region, the edge set comprises a neighborhood corresponding to the central node, the neighborhood comprises other nodes in the node set that are connected to the central node via an edge, the neighborhood corresponds to one target region in the predetermined region, and predetermined urban entities corresponding to the nodes in the neighborhood are located in the target region, and the feature set comprises node features of nodes in the node set;
partitioning the target region into at least two sub-regions to obtain a region partition set;
obtaining a regional feature of each sub-region by performing a feature aggregation on node features corresponding to all nodes located in the same sub-region; and
updating a node feature of the central node based on the regional features of the sub-regions in the region partition set to obtain target feature data.

2. The data generation method according to claim 1, wherein the partitioning the target region into the at least two sub-regions to obtain the region partition set comprises:
performing an M-head region partition on the target region based on a target partition manner to obtain the region partition set, wherein the region partition set comprises M region partition subsets in one-to-one correspondence with M heads of the M-head region partition, and each of the M region partition subsets comprises at least two sub-regions, and wherein partition parameters corresponding to different heads of the M-head region partition are different, where M is an integer greater than 1, and the partition parameters comprise at least one of: a position parameter of a partition line in the target region, and a distance parameter between different partition lines.

3. The data generation method according to claim 2, wherein the target partition manner comprises a first sub-partition manner and a second sub-partition manner, and an i-th head of the M-head region partition performed on the target region based on the target partition manner comprises:
partitioning the target region into at least two fan-shaped sub-regions centered at a target position point based on the first sub-partition manner to obtain a first region group, wherein the first region group comprises the at least two fan-shaped sub-regions and a central sub-region, the central sub-region being a region where the target position point is located; and
partitioning the target region into at least two ring-shaped sub-regions centered at the target position point based on the second sub-partition manner to obtain a second region group, wherein the second region group comprises the at least two ring-shaped sub-regions and the central sub-region,
wherein the target position point is a position point of the predetermined urban entity corresponding to the central node in the target region, wherein an i-th region partition subset comprises the first region group and the second region group, and the i-th region partition subset is one of the M region partition subsets corresponding to the i-th head, and wherein the position parameter of the first sub-partition manner is different for different heads of the M-head region partition, and the distance parameter of the second sub-partition manner is different for different heads of the M-head region partition.

4. The data generation method according to claim 3, wherein the updating the node feature of the central node based on the regional features of the sub-regions in the region partition set to obtain the target feature data comprises:
fusing the regional features of the sub-regions in each first region group to obtain M first feature data in one-to-one correspondence with the M region partition subsets;
fusing the regional features of the sub-regions in each second region group to obtain M second feature data in one-to-one correspondence with the M region partition subsets; and
updating the node feature of the central node based on the M first feature data and the M second feature data to obtain the target feature data.

5. The data generation method according to claim 4, wherein the fusing the regional features of the sub-regions in each first region group to obtain the M first feature data comprises:
performing a feature concatenation on the regional features of the sub-regions in each first region group to obtain the M first feature data.

6. The data generation method according to claim 4, wherein the fusing the regional features of the sub-regions in each second region group to obtain the M second feature data comprises:
performing a feature concatenation on the regional features of the sub-regions in each second region group to obtain the M second feature data.

7. The data generation method according to claim 4, wherein the updating the node feature of the central node based on the M first feature data and the M second feature data to obtain the target feature data comprises:
performing a feature concatenation on the M first feature data to obtain a first updated feature;
performing a feature concatenation on the M second feature data to obtain a second updated feature; and
performing a weighted summation on the first updated feature and the second updated feature to obtain the target feature data.

8. A model training method comprising:
obtaining urban graph data of a predetermined region, wherein the urban graph data comprises a node set, an edge set, and a feature set, wherein the node set comprises a central node corresponding to a predetermined urban entity in the predetermined region, the edge set comprises a neighborhood corresponding to the central node, the neighborhood comprising other nodes in the node set that are connected to the central node via an edge, and the feature set comprises node features of nodes in the node set, and wherein the neighborhood corresponds to one target region in the predetermined region, and predetermined urban entities corresponding to the nodes in the neighborhood are located in the target region;
updating the node feature of each central node in the feature set to obtain the target feature set, the target feature set comprising target feature data of each node in the node set, wherein the updating the node feature of each central node in the feature set to obtain the target feature set comprises: partitioning the target region into at least two sub-regions to obtain a region partition set; obtaining a regional feature of each sub-region by performing a feature aggregation on node features corresponding to all nodes located in the same sub-region; and updating a node feature of the central node based on the regional features of the sub-regions in the region partition set to obtain the target feature data; and
training a pre-constructed initial urban indicator generation model based on the node set, the edge set, and the target feature set to obtain a target model, wherein the target model is used for generating a score value of a predetermined urban indicator, and the predetermined urban indicator is an urban indicator associated with the predetermined urban entities.

9. The model training method according to claim 8, wherein the partitioning the target region into the at least two sub-regions to obtain the region partition set comprises:
performing an M-head region partition on the target region based on a target partition manner to obtain the region partition set, wherein the region partition set comprises M region partition subsets in one-to-one correspondence with M heads of the M-head region partition, and each of the M region partition subsets comprises at least two sub-regions, and wherein partition parameters corresponding to different heads of the M-head region partition are different, where M is an integer greater than 1, and the partition parameters comprise at least one of: a position parameter of a partition line in the target region, and a distance parameter between different partition lines.

10. The model training method according to claim 9, wherein the target partition manner comprises a first sub-partition manner and a second sub-partition manner, and an i-th head of the M-head region partition performed on the target region based on the target partition manner comprises:
partitioning the target region into at least two fan-shaped sub-regions centered at a target position point based on the first sub-partition manner to obtain a first region group, wherein the first region group comprises the at least two fan-shaped sub-regions and a central sub-region, the central sub-region being a region where the target position point is located; and
partitioning the target region into at least two ring-shaped sub-regions centered at the target position point based on the second sub-partition manner to obtain a second region group, wherein the second region group comprises the at least two ring-shaped sub-regions and the central sub-region,
wherein the target position point is a position point of the predetermined urban entity corresponding to the central node in the target region, wherein an i-th region partition subset comprises the first region group and the second region group, and the i-th region partition subset is one of the M region partition subsets corresponding to the i-th head, and wherein the position parameter of the first sub-partition manner is different for different heads of the M-head region partition, and the distance parameter of the second sub-partition manner is different for different heads of the M-head region partition.

11. The model training method according to claim 10, wherein the updating the node feature of the central node based on the regional features of the sub-regions in the region partition set to obtain the target feature data comprises:
fusing the regional features of the sub-regions in each first region group to obtain M first feature data in one-to-one correspondence with the M region partition subsets;
fusing the regional features of the sub-regions in each second region group to obtain M second feature data in one-to-one correspondence with the M region partition subsets; and
updating the node feature of the central node based on the M first feature data and the M second feature data to obtain the target feature data.

12. The model training method according to claim 11, wherein the fusing the regional features of the sub-regions in each first region group to obtain the M first feature data comprises:
performing a feature concatenation on the regional features of the sub-regions in each first region group to obtain the M first feature data.

13. The model training method according to claim 11, wherein the fusing the regional features of the sub-regions in each second region group to obtain the M second feature data comprises:
performing a feature concatenation on the regional features of the sub-regions in each second region group to obtain the M second feature data.

14. The model training method according to claim 11, wherein the updating the node feature of the central node based on the M first feature data and the M second feature data to obtain the target feature data comprises:
performing a feature concatenation on the M first feature data to obtain a first updated feature;
performing a feature concatenation on the M second feature data to obtain a second updated feature; and
performing a weighted summation on the first updated feature and the second updated feature to obtain the target feature data.

15. An electronic device comprising:
at least one processor; and
a memory in communication connection with the at least one processor,
wherein the memory stores instructions executable by the at least one processor, and the instructions, when executed by the at least one processor, cause the at least one processor to perform a data generation method, comprising:
obtaining urban graph data of a predetermined region, wherein the urban graph data comprises a node set, an edge set, and a feature set, the node set comprises a central node corresponding to a predetermined urban entity in the predetermined region, the edge set comprises a neighborhood corresponding to the central node, the neighborhood comprises other nodes in the node set that are connected to the central node via an edge, the neighborhood corresponds to one target region in the predetermined region, and predetermined urban entities corresponding to the nodes in the neighborhood are located in the target region, and the feature set comprises node features of nodes in the node set;
partitioning the target region into at least two sub-regions to obtain a region partition set;
obtaining a regional feature of each sub-region by performing a feature aggregation on node features corresponding to all nodes located in the same sub-region; and
updating a node feature of the central node based on the regional features of the sub-regions in the region partition set to obtain target feature data.

16. The electronic device according to claim 15, wherein the partitioning the target region into the at least two sub-regions to obtain the region partition set comprises:
performing an M-head region partition on the target region based on a target partition manner to obtain the region partition set, wherein the region partition set comprises M region partition subsets in one-to-one correspondence with M heads of the M-head region partition, and each of the M region partition subsets comprises at least two sub-regions, and wherein partition parameters corresponding to different heads of the M-head region partition are different, where M is an integer greater than 1, and the partition parameters comprise at least one of: a position parameter of a partition line in the target region, and a distance parameter between different partition lines.

17. The electronic device according to claim 16, wherein the target partition manner comprises a first sub-partition manner and a second sub-partition manner, and an i-th head of the M-head region partition performed on the target region based on the target partition manner comprises:
partitioning the target region into at least two fan-shaped sub-regions centered at a target position point based on the first sub-partition manner to obtain a first region group, wherein the first region group comprises the at least two fan-shaped sub-regions and a central sub-region, the central sub-region being a region where the target position point is located; and
partitioning the target region into at least two ring-shaped sub-regions centered at the target position point based on the second sub-partition manner to obtain a second region group, wherein the second region group comprises the at least two ring-shaped sub-regions and the central sub-region,
wherein the target position point is a position point of the predetermined urban entity corresponding to the central node in the target region, wherein an i-th region partition subset comprises the first region group and the second region group, and the i-th region partition subset is one of the M region partition subsets corresponding to the i-th head, and wherein the position parameter of the first sub-partition manner is different for different heads of the M-head region partition, and the distance parameter of the second sub-partition manner is different for different heads of the M-head region partition.

18. An electronic device, comprising:
at least one processor; and
a memory in communication connection with the at least one processor,
wherein the memory stores instructions executable by the at least one processor, and the instructions, when executed by the at least one processor, cause the at least one processor to perform the steps of the method according to claim 8.

19. A non-transitory computer-readable storage medium storing computer instructions, wherein the computer instructions cause a computer to perform the steps of the method according to claim 1.

20. A non-transitory computer-readable storage medium storing computer instructions, wherein the computer instructions cause a computer to perform the steps of the method according to claim 8.
